(19) United States
(12) Patent Application Publication
(10) Pub. No.: US 2018/0234999 A1
(43) Pub. Date: Aug. 16, 2018

(54) SUBFRAME CONFIGURATION INDICATION METHOD, SUBFRAME CONFIGURATION ACQUISITION METHOD, BASE STATION, AND USER EQUIPMENT

(71) Applicant: SHARP KABUSHIKI KAISHA, Sakai City , Osaka (JP)

(72) Inventors: MENG ZHANG, Shanghai (CN); QI JIANG, Shanghai (CN); RENMAO LIU, Shanghai (CN)

(21) Appl. No.: 15/750,259

(22) PCT Filed: Aug. 1, 2016
(86) PCT No.: PCT/CN2016/092683

§ 371 Date: Feb. 5, 2018

(30) Foreign Application Priority Data
Aug. 5, 2015 (CN) 201510474488.6

(51) Int. Cl. H04W 72/12; H04W 72/04; H04L 5/00

(52) U.S. Cl. CPC H04W 72/1273; H04W 72/0446; H04W 4/06; H04L 5/0048; H04W 72/0406

(57) ABSTRACT

The present application discloses a subframe configuration indication method executed by a base station, and a corresponding base station. The method comprises the following steps: including subframe configuration information of an Enhanced Physical Multicast Channel (E-PMCH) in a Radio Resource Control (RRC) signaling or a System Information Block (SIB) 13, wherein the E-PMCH is superposed with a basic PMCH (B-PMCH) by adopting Multi-user Superposition Transmission (MUST) technology; and sending the RRC signaling or the SIB 13 to a user equipment. The present application further discloses a subframe configuration acquisition method executed by a user equipment, and a corresponding user equipment.

### TECHNICAL FIELD

The present invention relates to the technical field of wireless communication. More particularly, the present invention relates to a subframe configuration indication method executed by a base station, a subframe configuration acquisition method executed by a user equipment, and a corresponding base station and user equipment.

### BACKGROUND

Modern wireless mobile communication systems present two significant characteristics. One is high-speed broadband, for example, the fourth generation wireless mobile communication system has a bandwidth of up to 100 MHz and a downlink speed of up to 1 Gbps. The other characteristic is mobile interconnection, which promotes emerging services, such as WAP, mobile phone video-on-demand, online navigation and the like. These two characteristics propose higher requirements for wireless mobile communication technology. Such requirements mainly include: ultrahigh-speed wireless transmission, inter-region interference suppression, mobile reliable signal transmission, distributed/centralized signal processing and the like. To satisfy the development requirements above, in a future, more enhanced Fourth Generation (4G) or Fifth Generation (5G) wireless mobile communication system, various corresponding key technologies will begin to be proposed and demonstrated, arousing the attention of researchers in the field. In October 2007, the International Telecommunication Union (ITU) approved the Worldwide Interoperability for Microwave Access (WiMAX) as the fourth third generation (3G) system standard. This event which occurred at the end of the 3G era is actually a preview of the 4G standard battle. In fact, in response to the challenge of streams of wireless Internet protocol (IP) technologies represented by Wireless Local Area Network (WLAN) and WiMax, since 2005 the 3rd Generation Partnership Project (3GPP) organization has embarked on a completely new system upgrade, i.e., standardization of Long Term Evolution (LTE). This is a quasi-fourth-generation system based on Orthogonal Frequency Division Multiplexing (OFDM) which was first released in early 2009 and started to be commercially available globally in 2010. Meanwhile, the 3GPP organization has launched the standardization of the Fourth Generation (4G) wireless mobile communication system in the first half of 2008. This system is called a Long Term Evolution Advanced (LTE-A) system. The key standardized document for the physical layer process of the system was completed in early 2011. In November 2011, the ITU organization officially announced in Chongqing, China that LTE-A systems and WiMax systems are two official standards for 4G systems. At present, the commercial process of LTE-A systems is being gradually expanded worldwide. According to the challenges in the next decade, the following development needs for the enhanced fourth generation wireless mobile communication system are required:
a higher wireless broadband rate, with a focus on optimizing a localized cell hot area;
further improving the user experience, with a particular need to optimize communication services in the border area of a cell;
a need to continue studying new technology capable of improving the utilization efficiency of a spectrum, considering that an available spectrum cannot be expanded 1000 times;
high frequency spectra (5GHz or higher) must be put use to obtain larger communication bandwidths;
collaborative work of existing networks (2G/3G/4G, WLAN, WiMax, etc.) to share data traffic;
dedicated optimization for different businesses, applications, and services;
strengthening the system's ability to support large-scale machine communication;
flexible, intelligent and inexpensive network planning and network distribution;
designing a solution to save network power consumption and user equipment battery consumption.

In the conventional 3GPP LTE system, multiple pieces of user data can be transmitted over a single data stream, which is commonly referred to as Multi-user (MU) transmission technology. However, the traditional MU technology can obtain better performance only when the user's channels are as orthogonal as possible, which limits the flexibility of user scheduling to a certain extent. To this end, the 3GPP RAN # 67 plenary discussed a new research topic, that is, the study of Multi-user Superposition Transmission (MUST), the main purpose of which is to study the function of transmitting multiple pieces of user information through single-stream data in an overlapping and superimposed manner by adjusting the power of multiple user-modulated signals. Compared with the traditional MU technology, the MUST technology does not require orthogonality between channels from the user to the base station. Therefore, with the use of the MUST technology, the base station can schedule users more flexibly. At present, the 3GPP may also use the MUST technology in a Multimedia Broadcast Multicast System (MBMS), On the basis of a Basic Physical Multicase Channel (B-PMCH), the MUST technology is used to superpose an enhanced PMCH (E-PMCH) to achieve the goal of transmitting multiple PMCHs simultaneously.

However, for PMCH transmission using the MUST technology, the traditional configuration signaling related to PMCH transmission may encounter the following problems:
subframe configuration information of the E-PMCH cannot be indicated and acquired.

Therefore, configuration signaling related to the PMCH (e.g., Radio Resource Control (RRC) signaling) in the MUST mode needs to be redesigned.

### SUMMARY

In view of the above problem, the present invention proposes a novel subframe configuration indication and acquisition scheme to support PMCH transmission that uses the MUST technology.

According to a first aspect of the present invention, a subframe configuration indication method executed by a base station is provided. The method comprises: including subframe configuration information of an E-PMCH in RRC signaling or a SIB 13, wherein the E-PMCH is superposed with a B-PMCH by adopting MUST technology; and sending the RRC signaling or the SIB13 to a user equipment.

According to a second aspect of the present invention, a base station is provided. The base station comprises: a signaling processing unit, used to include subframe configuration indication information of an E-PMCH in RRC signaling or a SIB13, wherein the E-PMCH is superposed with a B-PMCH by adopting MUST technology; and a transceiver, used to send the RRC signaling or the SIB13 to a user equipment.

According to a third aspect of the present invention, a subframe configuration acquisition method executed by a user equipment is provided. The method comprises: receiving RRC signaling or a SIB13 including subframe configuration information of an E-PMCH from a base station, wherein the E-PMCH is superposed with a B-PMCH by adopting MUST technology; and extracting the subframe configuration information of the E-PMCH from the received RRC signaling or SIB13.

According to a fourth aspect of the present invention, a user equipment is provided. The user equipment comprises: a transceiver, used to receive RRC signaling or a SIB13 including subframe configuration information of an E-PMCH from a base station, wherein the E-PMCH is superposed with a B-PMCH by adopting MUST technology; and a signaling processing unit, used to extract the subframe configuration information of the E-PMCH from the received RRC signaling or SIB13.

In the above first, second, third and fourth aspects, the subframe configuration information of the E-PMCH may include one or more of the following:

a transmission interval of a Multicast Control Channel (MCCH) corresponding to the E-PMCH, which is indicated by a first information element (mcch-REpetitionPeriod-MUST-r13);

an update period of the MCCH corresponding to the E-PMCH, which is indicated by a second information element (mcch-ModificationPeriod-MUST-r13); and

a scheduling period of a Multicast Traffic Channel (MTCH) corresponding to the E-PMCH, which is indicated by a third information element (inch-SchedulingPeriod-MUST-r13).

Alternatively, the subframe configuration information of the E-PMCH may further comprise a radio frame on which the MCCH corresponding to the E-PMCH is scheduled and which is jointly indicated by the first information element (mcch-REpetitionPeriod-MUST-r13) and a fourth information element (mcch-REpetitionPeriod-MUST-r13).

Alternatively, SFN mod mcch-REpetitionPeriod-MUST-r13=mcch-Offset-MUST-r13, wherein SFN represents a frame number of the radio frame on which the MCCH corresponding to the E-PMCH is scheduled.

Alternatively, SFN mod mcch-ModificationPeriod-MUST-r13=0, wherein SFN represents a frame number of a radio frame on which the MCCH corresponding to the E-PMCH is changed.

Alternatively, SFN mod mch-SchedulingPeriod=0, wherein SFN represents a frame number of a radio frame on which an MTCH corresponding to the E-PMCH is scheduled.

### DESCRIPTION OF THE DRAWINGS

The above and other features of the present invention will be more apparent from the following detailed description taken in conjunction with the drawings, in which:

FIG. 1 is a flowchart illustrating a subframe configuration indication od executed by a base station according to an embodiment of the present invention;

FIG. 2 is a flowchart illustrating a subframe configuration acquisition method executed by a user equipment according to an embodiment of the present invention;

FIG. 3 is a sequence diagram illustrating respective processing of and signaling interaction between a base station and a user equipment according to an embodiment of the present invention;

FIG. 4 is a structural block diagram illustrating a base station according to an embodiment of the present invention; and

FIG. 5 is a structural block diagram illustrating a user equipment according to an embodiment of the present invention.

### DESCRIPTION OF THE EMBODIMENTS

The proposed subframe configuration indication scheme and subframe configuration acquisition scheme that support PMCH transmission using the MUST technology will be described below with reference to the accompanying drawings and detailed embodiments.

It is to be noted that the present invention shall not be limited to the specific embodiments described below. In addition, detailed descriptions of well-known technologies that are not directly related to the present invention are omitted for the sake of brevity, in order to avoid obscuring the understanding of the present invention.

Multiple embodiments according to the present invention are specifically described in example application environments of an LTE mobile communication system and its subsequent evolved versions. However, it is to be noted that the present invention is not limited to the following embodiments, but may be applied to more other wireless communication systems, such as a future 5G cellular communication system.

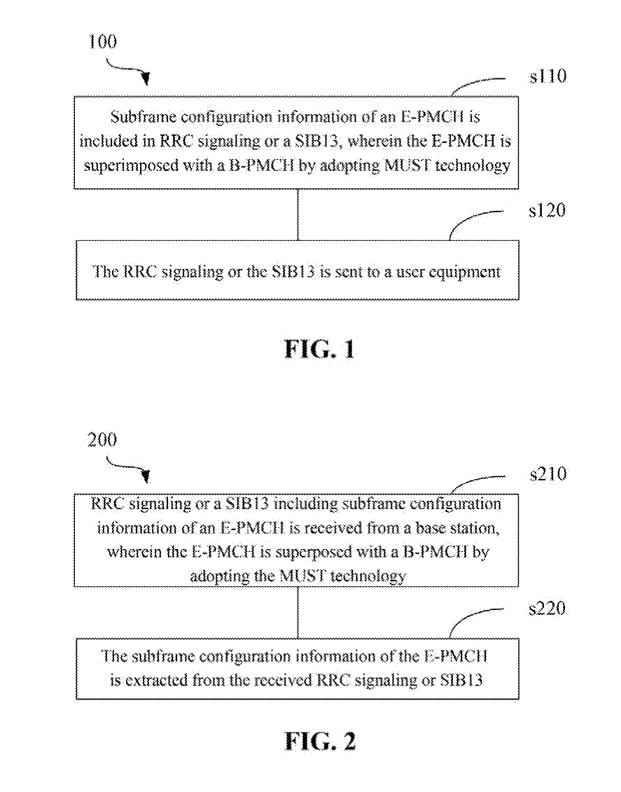

FIG. 1 shows a flowchart illustrating a subframe configuration indication method 100 executed by a base station according to an embodiment of the present invention. As shown in the figure, the method comprises the following steps.

Step s110, subframe configuration information of an E-PMCH is included in RRC signaling or a System Information Block (S13), wherein the E-PMCH is superposed with a B-PMCH by adopting the MUST technology.

As an embodiment, when there is an independent MCCH corresponding to the E-PMCH, the indication information of subframe configuration of the E-PMCH is transmitted by the following RRC signaling:

-- ASN1START

| | |
|---|---|
| MBSFN-AreaInfoList-r13 ::= | SEQUENCE (SIZE(1..maxMBSFN-Area)) OF MBSFN-AreaInfo-r13 |
| MBSFN-AreaInfo-r13 ::= | SEQUENCE { |

| | |
|---|---|
| mbsfn-AreaId-r13 | MBSFN-AreaId-r13, |
| non-MBSFNregionLength | ENUMERATED {s1, s2}, |
| notificationIndicator-r13 | INTEGER (0..7), |
| mcch-Config-r13 | SEQUENCE { |
| mcch-RepetitionPeriod-r13 | ENUMERATED {rf32, rf64, rf128, rf256}, |
| mcch-Offset-r13 | INTEGER (0..10), |
| mcch-ModificationPeriod-r13 | ENUMERATED {rf512, rf1024}, |
| mcch-RepetitionPeriod-MUST-r13 | ENUMERATED {rf32, rf64, rf128, rf256}, |
| mcch-Offset--MUST-r13 | INTEGER (0..7), |
| mcch-ModificationPeriod-MUST-r13 | ENUMERATED {rf512, rf1024}, |
| sf-AllocInfo-r13 | BIT STRING (SIZE(6)), |
| signallingMCS-r13 | ENUMERATED {n2, n7, n13, n19} |
| }, | |
| ... | |
| } | |
| -- ASN1STOP | |

herein, mcch-REpetitionPeriod-MUST-r13 is used to indicate the transmission interval of the MCCH corresponding to the E-PMCH. For example, rf32 indicates an interval of 32 radio frames, rf64 indicates an interval of 64 radio frames, and so on.

mcch-Offset-MUST-r13 and mcch-REpetitionPeriod-MUST-r13 may be used together to indicate on which radio frame the MCCH corresponding to the E-PMCH is scheduled. For example, the frame number SEN of the radio frame on which the MCCH is scheduled satisfies SEN mod mcch-REpetitionPeriod-MUST-r13=mcch-Offset-MUST-r13.

mcch-ModificationPeriod-MUST-r13 is used to indicate the update period of the MCCH corresponding to the E-PMCH.

As another embodiment, when there is an independent MTCH corresponding to the E-PMCH, the indication information of subframe configuration of the E-PMCH is transmitted by the following RRC signaling:

| | |
|---|---|
| PMCH-Config-r13 ::= | SEQUENCE { |
| sf-AllocEnd-MUST-r13 | INTEGER (0..1535), |
| dataMCS-MUST-r13 | CHOICE { |
| normal-r13 | INTEGER (0..28), |
| higerOrder-r13 | INTEGER (0..27) |
| }, | |
| mch-SchedulingPeriod-MUST-r13 | ENUMERATED{ |
| | rf4, rf8, rf16, rf32, rf64, rf128, rf256, rf512, rf1024} |
| ... | |
| } | |

herein, mch-SchedulingPeriod-MUST-r13 is used to indicate the period of the MTCH corresponding to the E-PMCH. For example, rf8 indicates an interval of 8 radio frames, rf16 indicates an interval of 16 radio frames, and so on. When SFN mod mch-SchedulingPeriod=0, the MTCH corresponding to the E-PMCH is scheduled on the radio frame indicated by the SFN.

As another embodiment, when the B-PMCH and the E-PMCH correspond to the same MCCH, the indication information including subframe configuration of the MCCH is transmitted by the following RRC signaling:

| | |
|---|---|
| -- ASN1START | |
| MBSFN-AreaInfoList-r13 ::= | SEQUENCE (SIZE(1..maxMBSFN-Area)) OF MBSFN-AreaInfo-r13 |
| MBSFN-AreaInfo-r13 ::= | SEQUENCE { |
| mbsfn-AreaId-r13 | MBSFN-AreaId-r13, |
| non-MBSFNregionLength | ENUMERATED {s1, s2}, |
| notificationIndicator-r13 | INTEGER (0..7), |
| mcch-Config-r13 | SEQUENCE { |
| mcch-RepetitionPeriod-r13 | ENUMERATED {rf32, rf64, rf128, rf256}, |
| mcch-Offset-r13 | INTEGER (0..10), |
| mcch-ModificationPeriod-r13 | ENUMERATED {rf512, rf1024}, |
| sf-AllocInfo-r13 | BIT STRING (SIZE(6)), |
| signallingMCS-r13 | ENUMERATED {n2, n7, n13, n19} |
| }, | |
| ... | |
| } | |
| -- ASN1STOP | |

herein, mcch-REpetitionPeriod-MUST-r13 is used to indicate the transmission interval of the same MCCH corresponding to both the B-PMCH and the E-PMCH. For example, rf32 indicates an interval of 32 radio frames, rf64 indicates an interval of 64 radio frames, and so on.

mcch-Offset-MUST-r13 and mcch-REpetitionPeriod-MUST-r13 may be used together to indicate on which radio frame the same MCCH corresponding to both the B-PMCH and E-PMCH is scheduled. For example, the frame number SFN of the radio frame on which the MCCH is scheduled satisfies SFN mod mcch-REpetitionPeriod-MUST-r13=mcch-Offset-MUST-r13.

mcch-ModificationPeriod-MUST-r13 is used to indicate the update period of the same MCCH corresponding to both the B-PMCH and the E-PMCH.

As another embodiment, when the B-PMCH and the E-PMCH correspond to the same MTCH, the subframe configuration indication information of the MTCH corresponding to the E-PMCH is transmitted by the following RRC signaling:

| | |
|---|---|
| PMCH-Config-r13 ::= | SEQUENCE { |
| sf-AllocEnd-r13 | INTEGER (0..1535), |
| dataMCS-r13 | CHOICE { |
| normal-r13 | INTEGER (0..28), |
| higerOrder-r13 | INTEGER (0..27) |
| }, | |
| mch-SchedulingPeriod-r13 | ENUMERATED { |
| | rf4, rf8, rf16, rf32, rf64, rf128, rf256, rf512, |
| rf1024}, | |
| mch-SchedulingPeriod-MUST-r13 | ENUMERATED{ |
| | rf4, rf8,rf16,rf32,rf64,rf128,rf256,rf512,rf1024} |
| ... | |
| } | |

herein, mch-SchedulingPeriod-MUST-r13 is used to indicate the period of the MTCH corresponding to the E-PMCH. rf8 indicates an interval of 8 radio frames, rf16 indicates an interval of 16 radio frames, and so on. When SFN mod mch-SchedulingPeriod=0, the MTCH corresponding to the E-PMCH is scheduled on the radio frame indicated by the SFN.

In step s120, the RRC signaling or the SIB13 produced in step s110 is sent to the user equipment.

By executing the above subframe configuration indication method 100, the base station can indicate the subframe configuration of the E-PMCH to the user equipment, so as to effectively support PMCH transmission that uses the MUST technology.

The present invention further proposes a subframe configuration acquisition method 200 executed by a user equipment, which corresponds to the above subframe configuration indication method 100 executed by the base station. As shown in FIG. 2, the method 200 comprises the following steps.

Step s210, RRC signaling or a SIB13 including subframe configuration information of an E-PMCH is received from a base station, wherein the E-PMCH is superposed with the B-PMCH by adopting the MUST technology.

Step s220, the subframe configuration information of the B-PMCH and the E-PMCH is extracted from the received RRC signaling or SIB13.

As those skilled in the art will appreciate, the RRC signaling or the SIB13 received by the user equipment from the base station in the method 200 is exactly the RRC signaling or the SIB13 sent by the base station to the user equipment in the method 100.

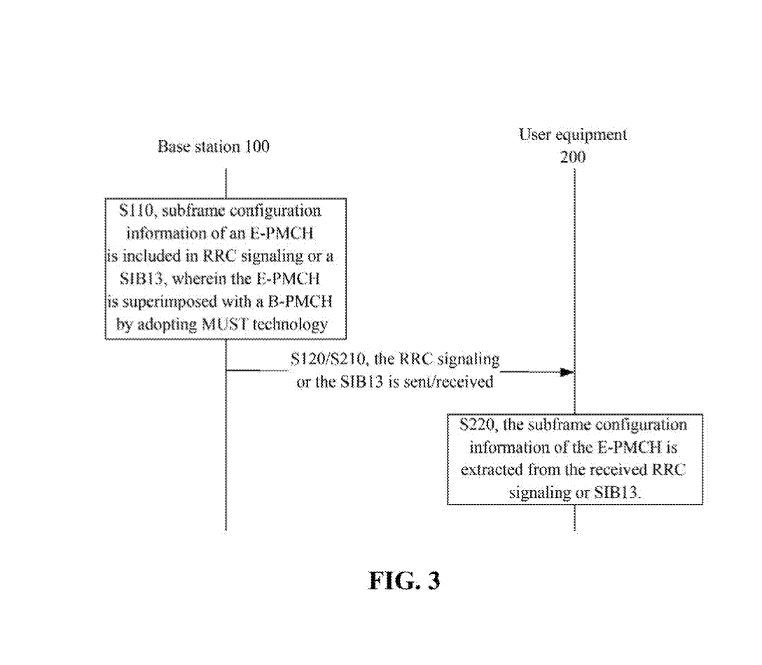

For ease of understanding, FIG. 3 further illustrates a sequence diagram showing respective processing of and signaling interaction between the base station and the user equipment according to an embodiment of the present invention. As shown in the figure, firstly, step s110 in the method 100 is executed at a base station side; and subframe configuration information of the E-PMCH is included in the RRC signaling or the SIB13. Then step s120 in the method 100 is executed to send the RRC signaling or the SIB13 produced in step s110 to the user equipment. Correspondingly, step s210 in the method 200 is executed at a user equipment side to receive the RRC signaling or the SIB13 including the subframe configuration information of the E-PMCH from the base station. Then, step s220 is executed to extract the subframe configuration information of the E-PMCH from the received RRC signaling or SIB13.

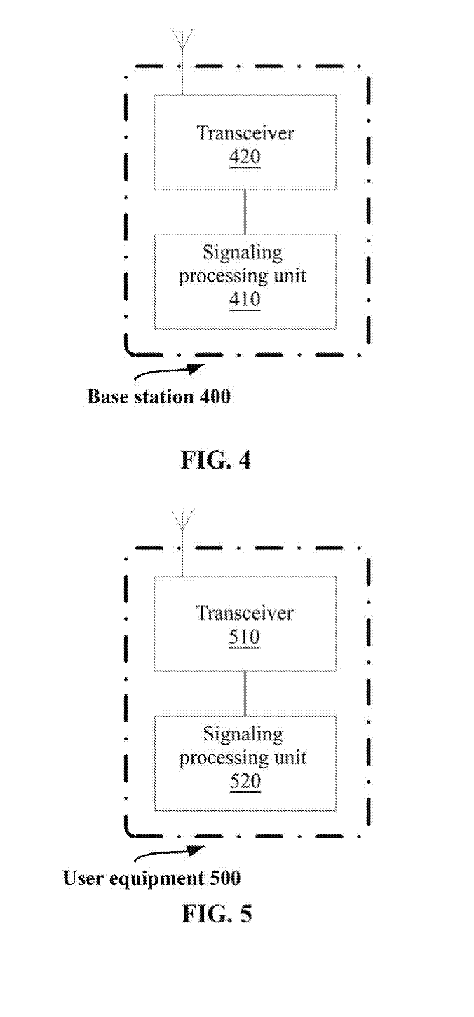

FIGS. 4 and 5 respectively illustrate structural block diagrams of a base station 400 and a user equipment 500 corresponding to the subframe configuration indication method executed by the base station, and the subframe configuration acquisition method executed by the user equipment described with reference to FIGS. 1 and 2.

As shown in FIG. 4, the base station device 400 comprises a signaling processing unit 410 and a transceiver 420. The signaling processing unit 410 is used to include the subframe configuration information of the E-PMCH in the RRC signaling or the SIB13. The transceiver 420 is used to send the RRC signaling or the SIB13 to the user equipment.

As shown in FIG. 5, the user equipment 500 includes a transceiver 510 and a signaling processing unit 520. The transceiver 510 is used to receive the RRC signaling or the SIB13 including the subframe configuration information of the E-PMCH from the base station. The signaling processing unit 520 is used to extract the subframe configuration information of the E-PMCH from the received RRC signaling or SIB13.

It is to be understood that the above-described embodiments of the present invention may be implemented by software or by hardware or by a combination of both software and hardware. For example, various components inside the base station and the user equipment in the above-described embodiments may be implemented by various devices, which include, but are not limited to: analog circuit devices, digital circuit devices, digital signal processing (DSP) circuits, programmable processors, application specific integrated circuits (ASICs), field programmable gate arrays (FPGAs), programmable logic devices (CPLDs), and the like.

In the present application, a “base station” refers to a mobile communication data and control switching center provided with a larger transmitting power and a wider coverage area and including functions such as resource allocation and scheduling, and data receiving and sending. A “user equipment” refers to a user mobile terminal, for example, a terminal device that can wirelessly communicate with a base station or a micro base station, such as a mobile phone, and a notebook.

In addition, the embodiments of the present invention disclosed herein may be implemented on a computer program product. More specifically, the computer program product is a product provided with a computer-readable medium having computer program logic encoded thereon that, when executed on a computing device, provides related operations to implement the above-described technical solutions of the present invention. When executed on at least one processor of a computing system, the computer program logic causes the processor to perform the operations (methods) described in the embodiments of the invention. Such an arrangement of the present invention is typically provided as software, codes and/or other data structures disposed on or encoded on a computer-readable medium such as an optical medium (eg, a CD-ROM), a floppy disk or a hard disk, or other media such as firmware or microcode on one or more ROM or RAM or PROM chips, or downloadable software images and shared databases in one or more modules etc. Software or firmware or such configuration may be installed on a computing device such that one or more processors in the computing device perform the technical solutions described in the embodiments of the present invention.

While the present invention has been illustrated in connection with the preferred embodiments of the present invention, it will be understood by those skilled in the art that various modifications, substitutions, and alterations may be made to the present invention without departing from the spirit and scope of the invention. Therefore, the present invention should not be limited by the above-described embodiments, but should be defined by the appended claims and their equivalents.

1. A subframe configuration indication method executed by a base station, comprising the following steps:
including subframe configuration information of an E-PMCH in RRC signaling or a SIB13, wherein the E-PMCH is superposed with a B-PMCH by adopting MUST technology; and
sending the RRC signaling or the SIB13 to a user equipment.

2. The method according to claim 1, wherein the subframe configuration information of the E-PMCH comprises one or more of the following:
a transmission interval of an MCCH corresponding to the E-PMCH indicated by a first information element (mcch-REpetitionPeriod-MUST-r13);
an update period of the MCCH corresponding to the E-PMCH indicated by a second information element (mcch-ModificationPeriod-MUST-r13); and
a scheduling period of an MTCH corresponding to the E-PMCH indicated by a third information element (mch-SchedulingPeriod-MUST-r13).

3. The method according to claim 2, wherein the subframe configuration information of the E-PMCH further comprises a radio frame on which the MCCH corresponding to the E-PMCH is scheduled, which is jointly indicated by the first information element (mcch-REpetitionPeriod-MUST-r13) and a fourth information element (mcch-REpetitionPeriod-MUST-r13).

4. The method according to claim 3, wherein SEN mod mcch-REpetitionPeriod-MUST-r13=mcch-Offset-MUST-r13, wherein SFN represents a frame number of the radio frame on which the MCCH corresponding to the E-PMCH is scheduled.

5. The method according to claim 2, wherein SFN mod mcch-ModificationPeriod-MUST-r13=0, wherein SFN represents a frame number of a radio frame on which the MCCH corresponding to the E-PMCH is changed.

6. The method according to claim 2, wherein SFN mod mch-SchedulingPeriod=0, wherein SFN represents a frame number of a radio frame on which the MTCH corresponding to the E-PMCH is scheduled.

7. A base station, comprising:
a signaling processing unit, used to include subframe configuration indication information of an E-PMCH in RRC signaling or a SIB13, wherein the E-PMCH is superposed with a B-PMCH by adopting MUST technology;
and a transceiver, used to send the RRC signaling or the SIB13 to a user equipment.

8. A subframe configuration acquisition method executed by a user equipment, comprising:
receiving RRC signaling or a SIB13 including subframe configuration information of an E-PMCH from a base station, wherein the E-PMCH is superposed with a B-PMCH by adopting MUST technology; and
extracting the subframe configuration information of the E-PMCH from the received RRC signaling or SIB13.

9. A user equipment, comprising:
a transceiver, used to receive RRC signaling or a SIB13 including subframe configuration information of an E-PMCH from a base station, wherein the E-PMCH is superposed with a B-PMCH by adopting MUST technology; and
a signaling processing unit, used to extract the subframe configuration information of the E-PMCH from the received RRC signaling or SIB13.
